(19) United States
(12) Patent Application Publication
(10) Pub. No.: US 2011/0126828 A1
(43) Pub. Date: Jun. 2, 2011

(54) Personal air purifier

(76) Inventors: Fu-Chi Wu, Northridge, CA (US); Steven Wu, Northridge, CA (US)

(21) Appl. No.: 12/591,673

(22) Filed: Nov. 27, 2009

(51) Int. Cl. A62B 7/10; B01J 19/08; B01D 53/00; A45F 3/14

(52) U.S. Cl. 128/201.25; 422/120; 422/121; 128/205.12; 224/257

(57) ABSTRACT

This invention relates to a personal air purifier having a housing with a filtering-and-purifying unit, a fan and an air-velocity-controlling unit therein. Under the control of the air-velocity-controlling unit, the fan can draw air through an air inlet into the housing and supply it via the filtering-and-purifying unit and a vent hole to the user, with comfortable air pressure and the filtering-and-purifying unit can purify most of the harmful substances from the air, making the air well purified. The vent hole is formed in the housing and connected with a duct that is extending to the user's nostril to supply the well purified air to the user. The personal air purifier is able to be carried on the shoulder or belt of the user anywhere, and is able to be activated by the solar energy when it is used outdoors.

### BACKGROUND OF THE INVENTION

1. Field of the Invention

The present invention relates to an air purifier, more particularly to a personal air purifier having a housing provided therein with a filtering-and-purifying unit, a fan and an air-velocity-controlling unit. The fan is for drawing air through an air inlet formed at one end of the housing into the same under the control of the air-velocity-controlling unit. The filtering-and-purifying unit is containing one or more purifying components for purifying most of the harmful substances from the air, so as to make the air well purified. The purified air is then supplied through a vent hole formed at another end of the housing and connected with a duct that is distally provided with at least one nostril plug for fitting into user's nostril. Under the control of said air-velocity-control unit, the purified air can be effectively delivered to the user's nostril with appropriate pressure. By using the personal air purifier, a user can easily obtain purified and clean air anywhere he/she may go to or stay at. Therefore, the personal air purifier of the present invention is particularly suitable for exercisers, pedestrians, outdoor enthusiasts, inhabitants and workers in epidemic areas, factory workers, miners, office workers, students, bus/train/airplane passengers, patients, medical professionals, firemen and armies, etc.

2. Description of Related Art

With the rapid progress of industries and commerce contributed by the highly developed technologies, people enjoy the civilization as well as the convenience realized by various means of transport. For example, aircraft, vessels, and vehicles have become essential transport tools for the busy commercial activities taking place in our daily life. While bringing convenience to human society, these transport tools do emit considerable waste gas that seriously pollutes the atmosphere people depend on for living. Such waste gas, together with harmful particles, dust, animal hairs, fibers, and industrial emission, is acutely threatening human health. As a result of continuously inhaling these foreign substances in the air, people avoidably have their health adversely affected and even suffer from diseases caused by these harmful substances. Besides, in recent years, many lethal, epidemic viruses are spread through air. All these facts emphasize the importance of purifying harmful substances and viruses from the air we inhale.

For a long time, in order to avoid inhaling polluted, harmful air, in addition to using various air filters or air purifiers settled indoor; wearing masks is the most popular way that people perform in public places or outdoors; there are many types of masks, each having its respective purpose, for people's option. For example, commercially available masks include those for general use, for medical use, for industrial use, for epidemic prevention, and for smoke protection, all sold in different price levels. Although wearing a mask can somehow help reduce inhalation of polluted, harmful air or viruses carried by the air, the purifying capability of the conventional masks is limited. While purifying air, masks unavoidably block air flow and thus cause people wearing them to breathe strenuously. Particularly, in places where the air is bad or thin, wearing a mask can make the wearer uncomfortable due to sultry feeling and insufficient air inhalation. This is the unsolved problem about using conventional masks for air purifying.

Further, current air purifier only can be used for indoors. There is no vent hole designed to deliver enough air pressure via a dust to user's nostril to breath in the purified air, so it cannot be used as personal air purifier.

### SUMMARY OF THE INVENTION

One objective of the present invention is to provide a personal air purifier. The purifier has a housing provided therein with a filtering-and-purifying unit containing one or more purifying components, and a fan and an air-velocity-controlling unit. The fan draws air through an air inlet that is composed of a plurality of openings formed and disposed at one end of the housing, and then the filtering-and-purifying unit purifies most of the harmful substances from the air, so as to make the air well purified for various purifying purposes. The housing is scalable in volume for better portability. The purifier thus can fully avoid the problems of the prior art, such as hindering breath, causing sultriness and in turn uncomfortableness, and poor purifying efficiency. The purifier further has a duct that is connected to a vent hole formed in another end of the housing and distally provided with a means for fitting with a nose of a user. Therefore, the purified air can be supplied through a vent hole and effectively delivered to the nose with appropriate air pressure under the control of the air-velocity-controlling unit by automatic or manual adjustment. By using the personal air purifier, a user can easily obtain purified and clean air anywhere. Therefore, the personal air purifier of the present invention is particularly suitable for exercisers, pedestrians, outdoor enthusiasts, inhabitant's and workers in epidemic areas, factory workers, miners, office workers, students, bus/train/airplane passengers, patients, medical professionals, firemen and armies, etc.

Another objective of the present invention is to provide a personal air purifier as described above. The purifier can further have a solar panel settled outside the housing so that when the air purifier is used outdoors in daytime, the solar panel is capable of collecting the solar energy that is subsequently converted by a photovoltaic conversion circuit into electric power for powering the fan and the purifying-and-purifying unit as well as recharging the battery inside.

### BRIEF DESCRIPTION OF THE DRAWINGS

The invention as well as a preferred mode of use, further objectives and advantages thereof will be best understood by reference to the following detailed description of an illustrative embodiments when read in conjunction with the accompanying drawing, wherein:

FIG. 1 is an exploded view of a personal air purifier according to one preferred embodiment of the present invention;

FIG. 2 is a sectional view of the assemble personal air purifier of FIG. 1;

FIG. 3 is a perspective view of the personal air purifier of the present invention;

FIG. 4 is a schematic drawing showing the personal air purifier with a cover of its battery-accommodating recess opened for accessing batteries therein;

FIG. 5 is a schematic drawing showing a user carrying the personal air purifier on his shoulder by means of a carrying strap;

FIG. 6 is a schematic drawing showing the personal air purifier attached to a waist band for a user to fasten the personal air purifier on his waist;

FIG. 7 is a schematic drawing showing the user carrying the personal air purifier at his waist;

FIG. 8, according to another preferred embodiment of the present invention, provides a schematic drawing showing the personal air purifier with a vent hole provided with a duct that is distally connected with a respirator;

FIG. 9, according to another preferred embodiment of the present invention, provides a schematic drawing showing the personal air purifier with a vent hole provided with a duct that is distally connected with a smoke hood; and

FIG. 10, according to another preferred embodiment of the present invention, provides a sectional view of the assembled personal air purifier with a high efficiency particulate arrestance filter provided therein.

### DETAILED DESCRIPTION OF THE PREFERRED EMBODIMENT

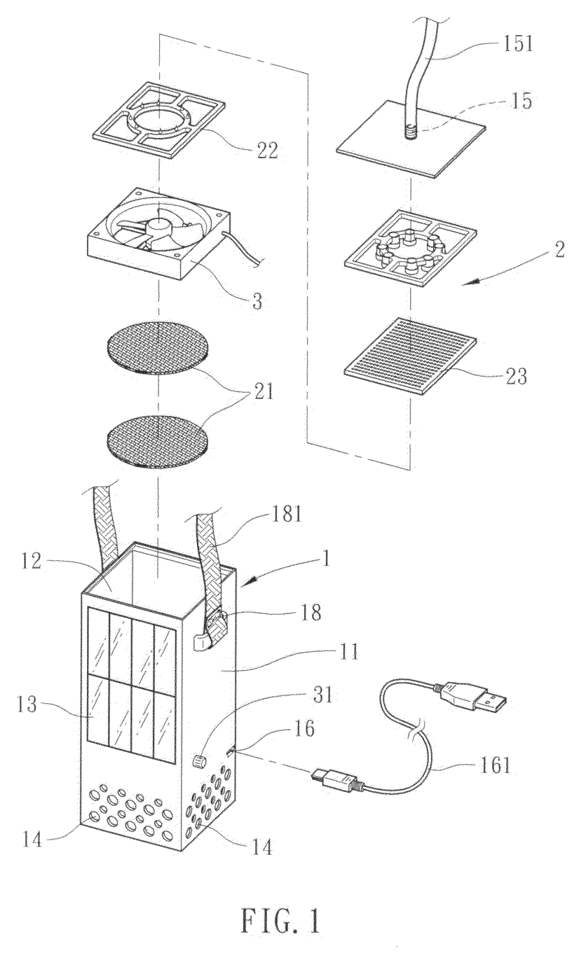

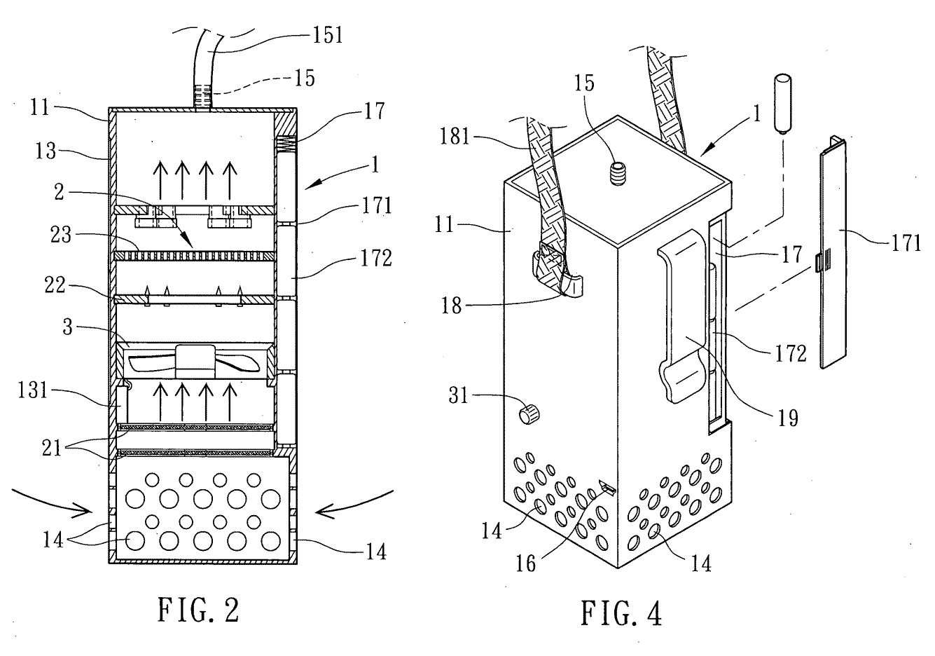

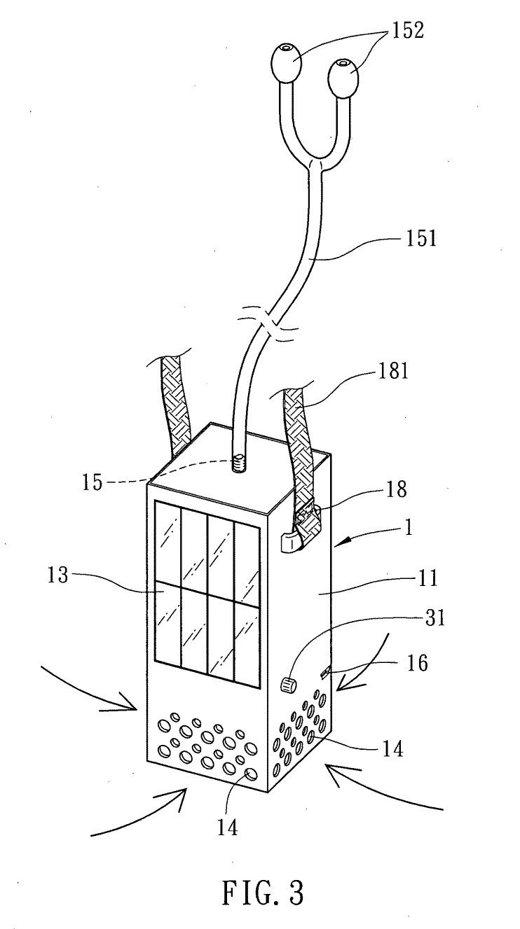

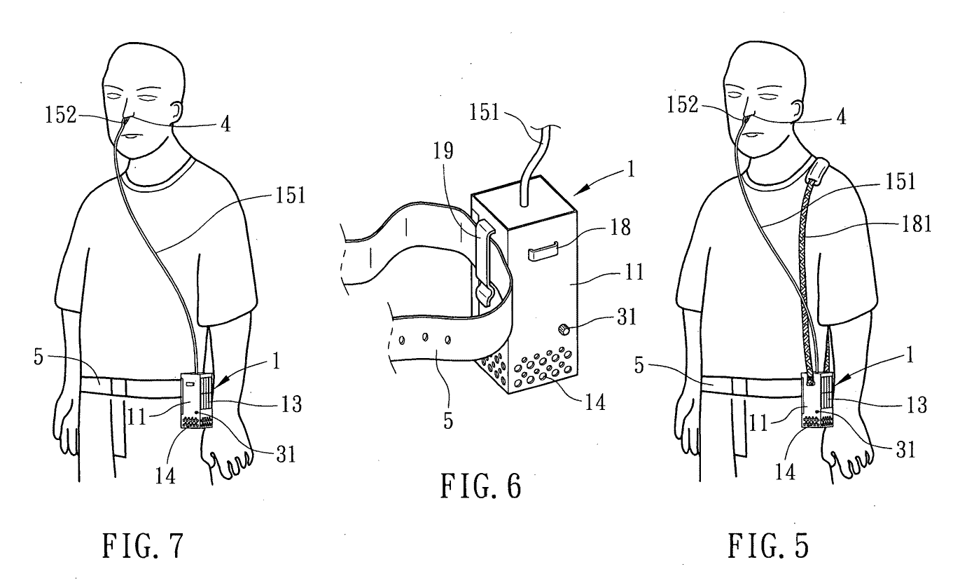

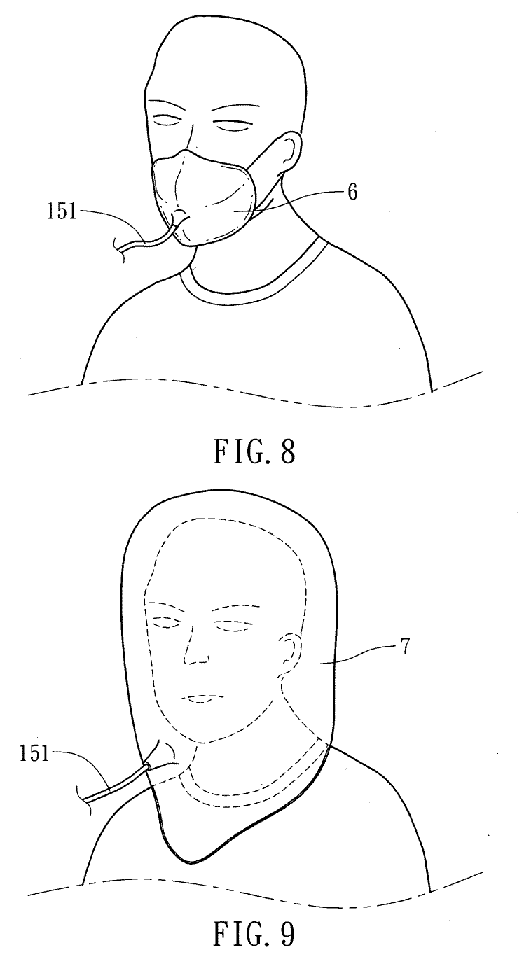

Referring to FIG. 1, FIG. 2 and FIG. 3 for a personal air purifier 1 according to one preferred embodiment of the present invention, the personal air purifier 1 has an inner space 12 defined by a housing 11 with two ends. The inner space 12 receives a filtering-and-purifying unit 2 containing one or more purifying components, a fan 3 and an air-velocity-controlling unit 31. The purifying components forming the filtering-and-purifying unit 2 may include, but are not limited to, any of an HEPA (High Efficiency Particulate Arrestance Filter), a made-of-nylon filter, an activated carbon filter, an ultraviolet lamp (UV lamp), a nano Ti02 filter, a formaldehyde blocker, a multifunction filter, a cation (anion) generator, a plasma generator, a high-voltage positive-power supplier, an electrostatic precipitator, a wet electrostatic precipitator, a static dust catcher 23, porous stone, activated carbon, a bioantibody filter and a metal filter. The aforementioned purifying components may be used alone or in conjunction in the present invention. In the present embodiment, two filters 21, a cation (anion) generator 22 and a static dust catcher 23 are adapted to form the filtering-and-purifying unit 2. In operation, the fan 3 draws air through an air inlet 14 that is composed of a plurality of openings formed and disposed at one end of the housing 11. Then the filtering-and-purifying unit 2 employs at least one of the filters 21, the cation (anion) generator 22, and the static dust catcher 23 to purify most of the harmful substances from the air, so as to make the air well purified. The purified air is then supplied out through a vent hole 15 and a duct 151. The vent hole 15 is formed at the other end of the housing 11. The duct 151 has two ends, one end of which is connected with the vent hole 15, through design of such vent hole 15, can connect one end of dust and vent hole 15, which purified air in housing 11, so better air pressure gathered by vent hole 15 is delivered to nostril. The other end of which is provided with two nostril plugs 152 for fitting into nostrils 4 of a user. Consequently, the purified air can be effectively delivered to the nostrils 4 with appropriate air pressure by automatically or manually adjusting the air-velocity-controlling unit 31 to control the rotational speed of the fan 3 and in turn the drawing and supplying velocity of the air, thereby the purified and clean air can be easily obtained. On the housing 11, there is a pair of fastening ring 18 for allowing a carrying strap 181 to be fixed thereon. By the carrying strap 181, the purifier 1 can be easily carried on a user's shoulder (as shown in FIG. 5) or hung at will. Moreover, a fastening buckle 19 may be provided at a lateral of the housing 11 for a waist belt 5 to pass therethrough so that the user can directly fasten the purifier 1 on his waist (as shown in FIG. 6 and FIG. 7). The power required by the operation of the fan 3 and the filtering-and-purifying unit 2 is supplied by batteries 172 received in a′ battery-accommodating recess 17. The battery-accommodating recess 17 is provided on the housing 11 with an opening. The battery-accommodating recess 17 is further equipped with a cover 171 configured to close the opening of the battery-accommodating recess 17 so as to keep the batteries firmly inside the recess (as shown in FIG. 4). Furthermore, the housing 11 may have a socket 16, so that the purifier 1 may be powered by a USB power source of a computer or wall power socket through a power cable 161. Alternatively, the purifier 1 may be connected with an external power source, such as an external battery unit, an external solar receiver or a car cigarette lighter, for indoor or charging the battery use. Additionally, the purifier 1 may have a solar panel 13, which is coupled with photovoltaic conversion circuit 131, and which is provided outside its housing 11, so that when the air purifier 1 is used outdoors in daytime, the solar panel 13 is capable of collecting the solar energy that is subsequently converted by the photovoltaic conversion circuit 131 into electric power for powering the fan 3, the cation (anion) generator 22 and the static dust catcher 23. The solar panel 13 may be configured to have a structure by which the solar panel 13 can be separated from the housing 11 and settled on an external article, electrically connecting with the batteries 172 inside the purifier 1 by means of an electric cord, so as to collect solar energy and supply power to and thus charge the batteries 172. In other embodiments, as shown in FIG. 8 and FIG. 9, a mask 6 or a smoke hood 7 may be used in place of the nostril plugs 152 to be attached to the duct 151 that are in connection with the vent hole 15. That is to say, the duct 151 is better to be configured to have a structure by which the nostril plugs 152, the mask 6 and the smoke hood 7 can be optionally attached to the other end of the duct 151. By the novel design of the present invention, the purifier 1 is particularly suitable for exercisers, pedestrians, outdoor enthusiasts, inhabitants and workers in epidemic areas, factory workers, miners, office workers, students, bus/train/airplane passengers, patients, medical professionals, firemen and armies, etc. Also, the housing 11 of the disclosed purifier 1 is practically scalable in size for meeting various needs in use.

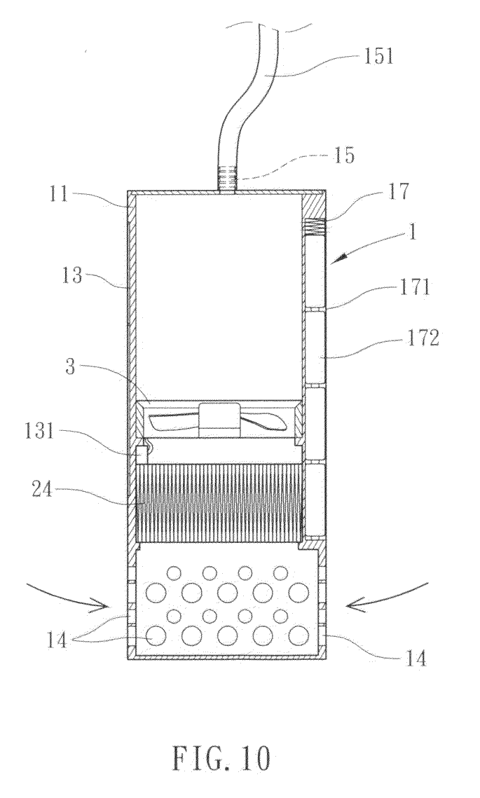

FIG. 10 shows a sectional view of a personal air purifier 1 of another embodiment of the present invention. This personal air purifier 1 is further equipped with a high efficiency particulate arrestance filter 24. With the presence of the high efficiency particulate arrestance filter 24 in the housing 11 of the purifier 1, the purifying efficiency of the purifier 1 can be even enhanced.

The present invention has been described with reference to the preferred embodiments and it is understood that those embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What the invention claimed is:

1. A personal air purifier, comprising:
a housing having an air inlet and at least one vent hole;
a filtering-and-purifying unit received in the housing, said filtering-and-purifying unit being composed of at least one purifying component;
at least one electric fan mounted in the housing; and
an air-velocity-controlling unit received in the housing;
wherein under the control of said air-velocity-controlling unit, the fan can draw air through said air inlet into said housing and supply it via said filtering-and-purifying unit and said vent hole to a user, and under the filtering and the purifying of said filtering-and-purifying unit, most of harmful substances in the air can be taken away and well purified air can be obtained by the user.

2. The personal air purifier as claimed in claim 1, further comprising at least one duct, each said duct having two ends, one end of which is connected with said vent hole, the other end of which is provided with a means for fitting a nose of the user.
through design of such vent hole, can connect one end of dust and vent hole, which purified air in housing, so better air pressure gathered by vent hole is delivered to nostrils.

3. The personal air purifier as claimed in claim 1, wherein the filtering-and-purifying unit includes at least one selected from the group consisting of a high efficiency particulate arrestance filter (HEPA), a made-of-nylon filter, an activated carbon filter, an ultraviolet lamp (UV lamp), a nano Ti02 filter, a formaldehyde blocker, a multifunction filter, a cation (anion) generator, a plasma generator, a high-voltage positive-power supplier, an electrostatic precipitator, a wet electrostatic precipitator, porous stone, activated carbon, a wet electrostatic precipitator, a static filter, a bioantibody filter and a metal filter.

4. The personal air purifier as claimed in claim 1, further comprising a fastening buckle attached on a lateral of said housing for a waist belt to pass through.

5. The personal air purifier as claimed in claim 1, wherein said housing is provided with a battery-accommodating recess for receiving at least one battery that supplies power required by the fan and the filtering-and-purifying unit, said battery-accommodating recess having an opening for putting battery into said recess, and a cover for closing said opening, so as to keep the battery inside said battery-accommodating recess.

6. The personal air purifier as claimed in claim 1, further comprising a socket attached on said housing, so that the purifier can be connected to a power source through a power cable for indoor use.

7. The personal air purifier as claimed in claim 1, further comprising a solar panel, which is coupled with a photovoltaic conversion circuit, and which is attaching on an outside part of said housing, thereby when the air purifier is used outdoors in daytime, said solar panel can collect solar energy, and said photovoltaic conversion circuit can convert the solar energy into electric power to supply said fan, said filtering-and-purifying unit and rechargable battery.

8. The personal air purifier as claimed in claim 2, wherein said means for fitting with the nose of the user is having at least one nostril plug for inserting into one nostril of the nose.

9. The personal air purifier as claimed in claim 2, wherein said means for fitting with the nose of the user is having a mask for covering the nose.

10. The personal air purifier as claimed in claim 2, wherein said means for fitting with the nose of the user is having a smoke hood for entirely covering a head of the user.

11. The personal air purifier as claimed in claim 1, wherein the fan and the filtering-and-purifying unit are configured to have a structure by which an external power source can be used to power them.

12. The personal air purifier as claimed in claim 7, wherein the solar panel is configured to have a structure by which said solar panel can be separated from said housing, and settled on an external article to collect solar energy and electrically supply power to charge battery, which is installed inside the battery-accommodating recess, by means of an electric cord.

13. The personal air purifier as claimed in claim 1, wherein at least one fastening ring attached on said housing for fixing a carrying strap therewith so that the whole air purifier can be carried on the user's shoulder or hung at will.
